(19) United States
(12) Patent Application Publication
(10) Pub. No.: US 2025/0149703 A1
(43) Pub. Date: May 8, 2025

(54) METHOD FOR PROVIDING A BATTERY ARRAY FOR A VEHICLE BATTERY PACK TO REDUCE ISOLATION RESISTANCE DROP IN THE BATTERY ARRAY

(71) Applicant: Ford Global Technologies, LLC, Dearborn, MI (US)

(72) Inventors: Insik Jeon, Novi, MI (US); Chi Paik, Grosse Ile, MI (US)

(21) Appl. No.: 18/502,578

(22) Filed: Nov. 6, 2023

(51) Int. Cl. H01M 50/227; B60L 50/60; H01M 50/211; H01M 50/249

(52) U.S. Cl. CPC H01M 50/227; B60L 50/60; H01M 50/211; H01M 50/249; H01M 2220/20

(57) ABSTRACT

A method of forming a battery pack from a plurality of battery pouch cells, where each battery pouch cell has a pouch and a pair of electrically conductive connectors extending from a portion of a sealed edge of the pouch, includes forming a battery array using a set of battery pouch cells selected from among the plurality of battery pouch cells; and encasing, for each battery pouch cell in the battery array, at least the pouch of the battery pouch cell with a polyurethane foam formed using a non-conductive physical blowing agent.

### TECHNICAL FIELD

The present disclosure relates to a method for generating a vehicle battery pack.

### BACKGROUND

A vehicle battery pack generally includes multiple battery arrays formed of a plurality of battery cells. In some instances, the battery cells may be a pouch-type battery cell having a flexible outer structure.

The battery manufacturing process for a pouch-type battery cell is similar to most battery processes except for the packaging step. Specifically, in one example, a battery manufacturing process can generally include an electrode preparation process, a cell assembly process, and a battery electrochemistry activation process. Among other steps, the cell assembly process can include an electrode shaping step, an electrode stacking step, and a cell stack packing step. During the electrode stacking step, anodes, separator sheets, and cathodes are repeatedly stacked, and electrical connectors (i.e., electrical contacting tabs) are welded to the electrode current collectors of the cell stack. To form a battery pouch cell, the cell stack is provided in a foil pouch during the cell stack packing step, and the foil pouch is then sealed with the electrical connectors extending from a sealed edge of the foil pouch.

### SUMMARY

In one form, the present disclosure is directed towards a method of forming a battery pack from a plurality of battery pouch cells, where each battery pouch cell has a pouch and a pair of electrically conductive connectors extending from a portion of a sealed edge of the pouch. The method includes forming a battery array using a set of battery pouch cells selected from among the plurality of battery pouch cells; and encasing, for each battery pouch cell in the battery array, at least the pouch of the battery pouch cell with a polyurethane foam formed using a non-conductive physical blowing agent.

In one form, the present disclosure is directed to a method of forming a battery pack from a plurality of battery pouch cells, where each battery pouch cell has a pouch and a pair of electrically conductive connectors extending from a portion of a sealed edge of the pouch. The method includes applying an insulative film on at least a portion of the pair of electrically conductive connectors; arranging a set of battery pouch cells selected from among the plurality of battery pouch cells in a parallel array to form a battery array; injecting a liquid polyurethane precursor having a blowing agent to the battery array; and curing the liquid polyurethane precursor having the blowing agent forming a structural support about the battery array.

In one form the present disclosure is directed to a method of forming a vehicle battery pack from a plurality of battery pouch cells, where each battery pouch cell has a pouch and a pair of electrically conductive connectors extending from a sealed edge of the pouch. The method includes applying an insulative film on at least a portion of the pair of electrically conductive connectors; arranging a set of battery pouch cells selected from among the plurality of battery pouch cells in a parallel array to form a battery array; applying a liquid polyurethane precursor having a non-conductive physical blowing agent to the battery array; and curing the liquid polyurethane precursor having the non-conductive physical blowing agent forming a structural support about the battery array.

### BRIEF DESCRIPTION OF THE DRAWINGS

FIG. 1 illustrate an electric vehicle having a battery pack in accordance with the present disclosure;

FIG. 2 illustrates the battery pack having a battery array in accordance with the present disclosure;

FIG. 3 is a flowchart of an example battery array formation process in accordance with the present disclosure;

FIG. 4A illustrates a plurality of battery cells and a battery array selected from the battery cells in accordance with the present disclosure;

FIG. 4B illustrates the battery array of FIG. 4A provided in a molding fixture to receive a liquid polyurethane precursor having a non-conductive physical blowing agent in accordance with the present disclosure;

FIG. 4C illustrates the battery array of FIG. 4B provided in an oven in accordance with the present disclosure;

FIG. 4D illustrates the battery array of FIG. 4C being encased in a polyurethane foam;

FIG. 5 is a flowchart of another example battery array formation process in accordance with the present disclosure;

FIG. 6A illustrates a battery cell having insulative film at a sealed edge of the battery cell in accordance with the present disclosure; and

FIG. 6B illustrates another battery cell having insulative film at a sealed edge of the battery cell accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

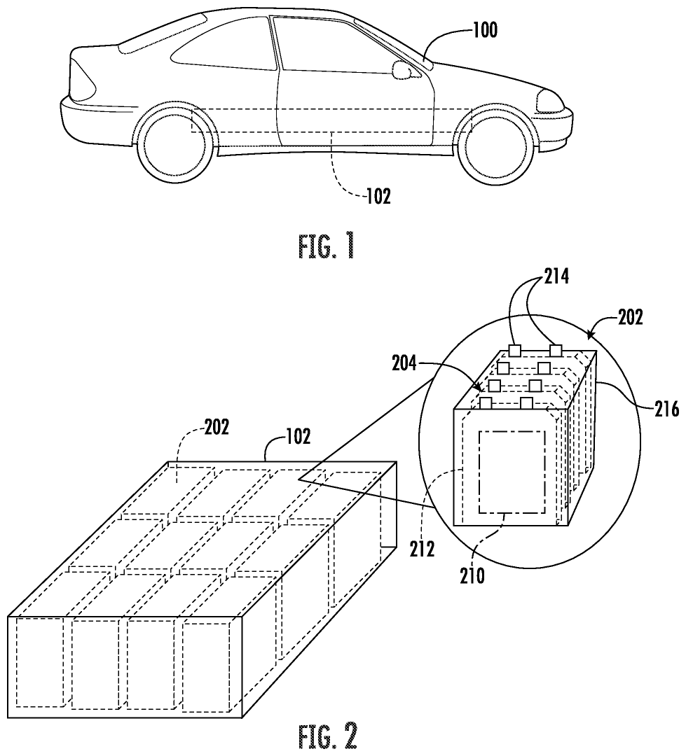

Referring to FIGS. 1 and 2 an electric vehicle (EV) 100, such as a fully electric vehicle or a hybrid vehicle having an internal combustion engine, receives all or some of its propulsion power from a battery pack 102 (i.e., traction battery pack). In one form, among other components, the batter pack 102 includes one or more battery arrays 202, where each battery array 202 includes a plurality of battery cells 204. In one form, each battery cell 204 is provided as a battery pouch cell and includes a battery electrode stack 210 (the battery electrode stack includes anodes, separator sheets, and cathodes), a pouch 212 containing the battery electrode stack, and a pair of electrically conductive connectors 214 (i.e., tabs) provided as a positive terminal and a negative terminal of the battery cell 204.

In one form, the pouch 212 includes at least one edge portion that is sealed to hold the battery electrode stack 210 within, and the pair of electrically conductive connectors 214 extend from at least one of the sealed edges of the pouch 212. While the pair of electrically conductive connectors 214 are shown as being arranged at the same sealed edge, the electrically conductive connectors 214 may extend from different sealed edges of the pouch 212. In addition, the shape of the pouch 212 may be adapted in various suitable ways and should not be limited to shape illustrated in the figures.

The battery cells 204 do not have a rigid enclosure since the pouch 212 is typically formed of a sealed flexible foil. Accordingly, the battery cells 204 are typically arranged in a structural support 216 to protect the battery cells 204 from physical disfiguration, increase seal strength of the pouch 212, and prevent cold-vent. In one form, the structural support 216 is formed of a polyurethane (PU) foam that further provides thermal insulation and mitigates cell-to-cell thermal propagation when the PU foam is blended with flame-retardant.

In one form, to provide the structural support 216 and with the battery cells 204 arranged to form the battery array 202, liquid PU precursors are initially injected into the battery array 202 surrounding the battery cells 204, and the liquid PU precursors is then expanded and cured to the corresponding solid PU foam forming the structural support 216.

In some applications, the liquid PU precursors may include isocyanates (30˜70%), polyols (10˜30%), flame-retardant (10˜60%), and blowing agents (1˜10%). Water is commonly used as a chemical blowing agent, which in-situ produces carbon dioxide gas to create foam structures while exothermically cured to solid PU foam. However, in a battery array application, water may increase electrical conductivity of the liquid PU precursors, which may cause drop of isolation resistance (IR) in the cell-array.

In one form, the present disclosure provides a battery array formation process to form a battery array with a structural support that reduces or prevents a drop in IR. Specifically and as described in detail herein, the structural support of the battery array is formed using non-aqueous and electrically non-conductive blowing agents (physical blowing agents) and/or insulative film is provided at electrically conductive portions of the battery cells, such as, but not limited to, the electrically conductive connector. Accordingly, the battery array of the present disclosure may not have a drop in IR, thereby improving operation of the battery array.

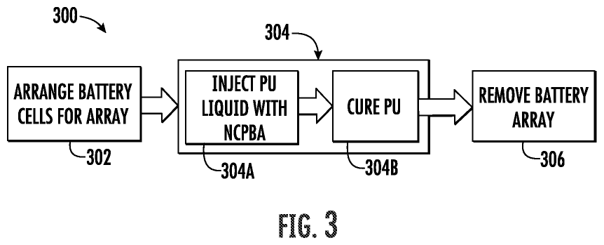

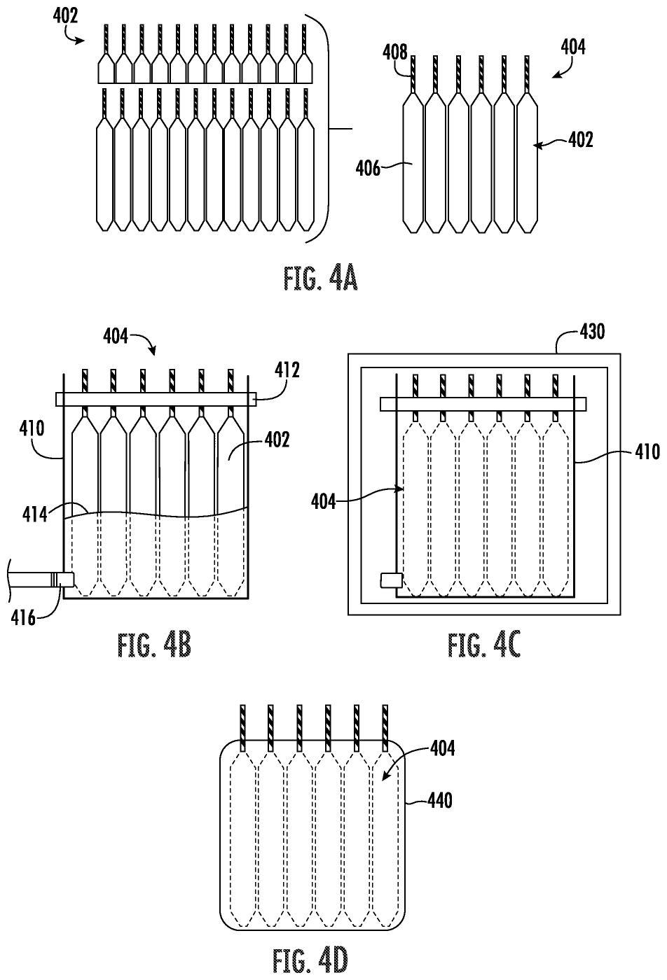

Referring to FIG. 3, an example battery array formation process 300 of the present disclosure is provided and described in correlation with FIGS. 4A, 4B, 4C, and 4D. At step 302, a plurality of battery cells 402 are obtained and a set of battery cells 402 selected from among the plurality of battery cells 402 are arranged to form a battery array 404. In one form, the battery cells 402 are provided as battery pouch cells formed using known techniques, where each battery pouch cell includes a pouch 406 and a pair of electrically conductive connectors 408 extending from a portion of a sealed edge of the pouch 406. In a nonlimiting example, FIG. 4A illustrates a side view of the battery cells 402 arranged in parallel.

Once arranged, the battery cells 402 for the battery array 404 are encased with a PU foam formed using a physical blowing agent in an encasing step 304. Specifically, the encasing step 304 may include injecting a liquid PU precursor with a non-conductive physical blowing agent (NCPBA) (step 304A), which may be a non-aqueous agent, and curing the liquid PU to form the PU foam (step 304B). Once cured to form the PU foam, the PU foam and battery cells 402 are cooled before being removed from the molding fixture, at step 306.

In a non-limiting example, referring to FIG. 4B, the battery cells 402 are provided in a molding fixture 410 having a lid 412 that is adapted to have the pair of conductive connectors 408 extend through the lid 412 via multiple openings (not shown). The molding fixture 410 may also be adapted to provide a gap between the battery cells 402. The liquid PU precursor 414 having a non-conductive physical blowing agent is injected into the molding fixture 410 via an inlet 416 of the fixture 410. In one form, the non-conductive physical blowing agent includes, but is not limited to, methylformate, n-pentane, cyclohexane, chlorofluorocarbons (CFCs), hydrogenated fluorocarbons (HFCs), hydrogenated chlorofluorocarbons (HCFCs), low-boiling saturated and unsaturated hydrocarbons, and/or hydrofluoroethers (HFEs).

In one form, the liquid PU precursor 414 flows between the gaps of the battery cells 402 and flows to cover at least the pouches 406 of the battery cells 402. In some variations the liquid PU precursor 414 is provided to cover the entire pouch and a portion of the electrically conductive connector that extends from the sealed edge of the pouch 406.

Referring to FIG. 4C, once the liquid PU precursor is provided, the molding fixture 410 having the battery array 404 and the liquid PU precursor 414 is placed in an oven 430 to cure the liquid PU 414 forming the PU foam. Referring to FIG. 4D, once cooled, the battery array 404 with PU foam 440 is removed from the fixture 410. The PU foam 440, which is formed with the non-conductive physical blowing agent, forms a support structure of the battery array 404 without reducing IR of the battery array.

The figures illustrate an example arrangement of the battery cells 402 and the molding fixture 410. It should be readily understood that the battery cells 402 may be arranged in various suitable ways, and that other types of molding fixtures may be used. In addition, the number of battery cells 402 used for the battery array 404 is not limited to six (6), and may be two (2) or more battery cells 402.

In another form, in addition to or in lieu of using a non-conductive physical blowing agent, the battery array formation process employs an insulative film that is applied to at least a portion of electrically conductive section of the battery cell 402. More particularly, referring to FIG. 5, an example battery array formation process 500 is provided, which is similar to the battery array formation process 300 of FIG. 3. Similar steps are identified with the same reference number, and the description of which is omitted for brevity.

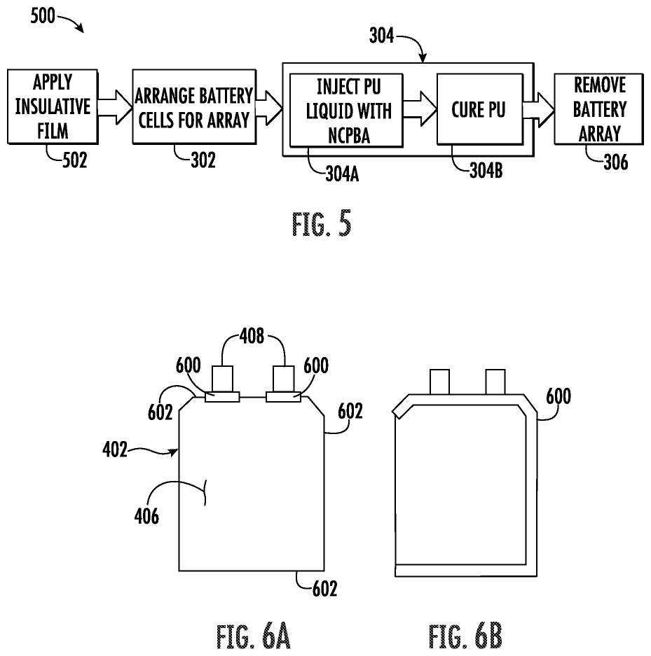

In process 500, prior to arranging the battery cells 402 in the battery array 404 at step 302, an insulative film is applied at least at the sealed edge having the pair of electrically conductive connectors 408, at step 502. More particularly, referring to FIG. 6A, an insulative film 600 is applied to cover a portion of a sealed edge 602 from which the electrically conductive connectors 408 extend from. For example, the insulative film is provided to cover a portion of the pouch 406 and a portion of the electrically conductive connectors 408 on both sides of the battery cell 402, thereby covering a portion of the sealed edge 602. In some variations, the insulative film 600 may also applied to other portions or all of the sealed edges 602, as provided in FIG. 6B. In a non-limiting example, the insulative film 600 may be an insulative tape or heat-laminated film.

Once placed, the process 500 includes steps 302, 304, and 306 of FIG. 3 in which the battery cells 402 are arranged in the battery array 404, encased in PU foam, and then removed. In one form, at step 304A, in lieu of using a liquid PU having a non-conductive physical blowing agent, other liquid PU precursors may be employed, such as, but not limited to a liquid PU having chemical blowing agent.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of forming a battery pack from a plurality of battery pouch cells, each battery pouch cell having a pouch and a pair of electrically conductive connectors extending from a portion of a sealed edge of the pouch, comprising:
forming a battery array using a set of battery pouch cells selected from among the plurality of battery pouch cells; and
encasing, for each battery pouch cell in the battery array, at least the pouch of the battery pouch cell with a polyurethane foam formed using a non-conductive physical blowing agent.

2. The method of claim 1, wherein the encasing, for each battery pouch cell in the battery array, at least the pouch of the battery pouch cell further comprises:
applying a liquid polyurethane precursor with the non-conductive physical blowing to the battery array; and
heating the battery array to cure the liquid polyurethane precursor to form the polyurethane foam.

3. The method of claim 1, wherein the non-conductive physical blowing agent includes at least one of methylformate, n-pentane, cyclohexane, chlorofluorocarbons (CFCs), hydrogenated fluorocarbons (HFCs), hydrogenated chlorofluorocarbons (HCFCs), low-boiling saturated, and unsaturated hydrocarbons, or hydrofluoroethers (HFEs).

4. The method of claim 1, further comprising applying an insulative film at least at the sealed edge having the pair of electrically conductive connectors prior to encasing.

5. The method of claim 4, wherein the insulative film is further applied to a portion of the sealed edge not having the pair of electrically conductive connectors.

6. The method of claim 4, wherein the insulative film is at least one of an insulative tape or a heat-laminated film.

7. A vehicle battery pack comprising,
a plurality of battery arrays formed by the method of claim 1.

8. A method of forming a battery pack from a plurality of battery pouch cells, each battery pouch cell having a pouch and a pair of electrically conductive connectors extending from a sealed edge of the pouch, comprising:
applying an insulative film on at least a portion of the pair of electrically conductive connectors;
arranging a set of battery pouch cells selected from among the plurality of battery pouch cells in a parallel array to form a battery array;
injecting a liquid polyurethane precursor having a blowing agent to the battery array; and
curing the liquid polyurethane precursor having the blowing agent forming a structural support about the battery array.

9. The method of claim 8, wherein the curing the liquid polyurethane precursor further comprises heating the battery array to cure the liquid polyurethane precursor to form a polyurethane foam as the structural support about the battery array.

10. The method of claim 8, wherein the blowing agent is a non-conductive physical blowing agent.

11. The method of claim 10, wherein the non-conductive physical blowing agent includes at least one methylformate, n-pentane, cyclohexane, chlorofluorocarbons (CFCs), hydrogenated fluorocarbons (HFCs), hydrogenated chlorofluorocarbons (HCFCs), low-boiling saturated and unsaturated hydrocarbons, or hydrofluoroethers (HFEs).

12. The method of claim 8, wherein the blowing agent is a non-aqueous physical blowing agent.

13. The method of claim 8, wherein the insulative film is further applied to a portion of the sealed edge not having the pair of electrically conductive connectors.

14. The method of claim 8, wherein the insulative film is at least one of an insulative tape or a heat-laminated film.

15. A vehicle battery pack comprising,
a plurality of battery arrays formed by the method of claim 8.

16. A method of forming a vehicle battery pack from a plurality of battery pouch cells, each battery pouch cell having a pouch and a pair of electrically conductive connectors extending from a sealed edge of the pouch, comprising:
applying an insulative film on at least a portion of the pair of electrically conductive connectors;
arranging a set of battery pouch cells selected from among the plurality of battery pouch cells in a parallel array to form a battery array;
applying a liquid polyurethane precursor having a non-conductive physical blowing agent to the battery array; and
curing the liquid polyurethane precursor having the non-conductive physical blowing agent forming a structural support about the battery array.

17. The method of claim 16, wherein the curing the liquid polyurethane precursor further comprises heating the battery array to cure the liquid polyurethane precursor to form a polyurethane foam as the structural support about the battery array.

18. The method of claim 17, wherein the non-conductive physical blowing agent is selected from among methylformate, n-pentane, cyclohexane, chlorofluorocarbons (CFCs), hydrogenated fluorocarbons (HFCs), hydrogenated chlorofluorocarbons (HCFCs), low-boiling saturated and unsaturated hydrocarbons, or hydrofluoroethers (HFEs).

19. The method of claim 16, wherein the insulative film is further applied to a portion of the sealed edge not having the pair of electrically conductive connectors.

20. The method of claim 16, wherein the insulative film is at least one of an insulative tape or a heat-laminated film.
